(19) United States
(12) Patent Application Publication
(10) Pub. No.: US 2026/0101380 A1
(43) Pub. Date: Apr. 9, 2026

(54) RANDOM ACCESS DURING CG-SDT

(71) Applicant: Telefonaktiebolaget LM Ericsson (publ), Stockholm (SE)

(72) Inventors: Oskar Myrberg, Norrköping (SE); Jan Christoffersson, Luleå (SE); Henrik Enbuske, Stockholm (SE); Revathy Narayanan, Sollentuna (SE)

(21) Appl. No.: 19/115,288

(22) PCT Filed: Oct. 31, 2023
(86) PCT No.: PCT/SE2023/051081

§ 371 Date: Mar. 26, 2025

Related U.S. Application Data
(60) Provisional application No. 63/422,208, filed on Nov. 3, 2022.

(51) Int. Cl. H04W 74/0833; H04W 72/115; H04W 76/27

(52) U.S. Cl. CPC H04W 74/0833; H04W 72/115; H04W 76/27

(57) ABSTRACT

Systems and methods are disclosed for random access during Configured Grant (CG) Small Data Transmission (SDT). In one embodiment, a method performed by a User Equipment (UE) comprises, while in an inactive state, transmitting, to a network node, a Radio Resource Control (RRC) Resume Request with first data using a CG occasion from among a plurality of CG occasions configured for the UE and determining that one or more criteria for performing a Random Access (RA) have been satisfied. The method further comprises, responsive to determining that the one or more criteria for performing a RA have been satisfied, performing a RA during which the UE retransmits the RRC Resume Request with the first data. In this manner, the UE does not have to wait for the next CG occasion to send a retransmission or time critical data, e.g., in the case of failure of the initial transmission.

### RELATED APPLICATIONS

This application claims the benefit of provisional patent application Ser. No. 63/422,208, filed Nov. 3, 2022, the disclosure of which is hereby incorporated herein by reference in its entirety.

### TECHNICAL FIELD

The present disclosure relates to a cellular communications network and, more specifically, to small data transmission in a cellular communications network.

### BACKGROUND

In 3rd Generation Partnership Project (3GPP) Release (Rel-)17, Mobile Originated Small Data Transmission (MO-SDT) was introduced for New Radio (NR) to reduce the signaling overhead for small uplink data payloads (see RP-200954 ‘New Work Item on NR small data transmissions in INACTIVE state’). Two solutions were introduced, namely, Random Access based SDT (RA-SDT) and Configured Grant SDT (CG-SDT). RA-SDT means that either the legacy 4-step Random Access Channel (RACH) procedure or the 2-step RACH procedure is used as a baseline but that a user-plane data payload can be appended (multiplexed with the RRCResumeRequest message) in Msg3 (4-step RACH) or MsgA (2-step RACH). CG-SDT means that the User Equipments (UEs) are configured via Radio Resource Control (RRC) to have periodic CG-SDT occasions which can, contention-free, be used for uplink transmission. In this way, Msg1 and Msg2 can be omitted, but it is a requirement that the UE has a valid Timing Advance (TA) and is uplink synchronized to be able to use the resources for transmission.

For Narrowband Internet of Things (NB-IoT) and Long Term Evolution (LTE) for Machine Type Communication (MTC) (LTE-M), similar signaling optimizations for small data have been introduced through Rel-15 Early Data Transmission (EDT) and Rel-16 Preconfigured Uplink Resources (PUR). The main differences for the NR SDT solutions are that the Rel-17 NR Small Data is only to be supported for RRC INACTIVE state, includes also 2-step RACH based small data, is supported by any NR UE (i.e. also Mobile Broadband (MBB) UEs and not limited to Internet of Things (IoT) UEs), and supports transmission of subsequent data (i.e. larger payload sizes which require more than one transmission).

For LTE, support for Mobile Terminated (MT) small data transmissions was later introduced in Rel-16, that is, supporting transmissions of small data payloads in the downlink. Several solutions were considered: ‘Data in paging’ (multiple versions), ‘Data in Msg2’, and ‘Data in Msg4’ (see overview in RAN2 email discussion R2-1901143 from RAN2 #105). ‘Data in paging’ was first ruled out (see meeting report R2-1903001), and later ‘Data in Msg2’ was ruled out (see UP MT-EDT email discussion outcome in R2-1910420, and meeting report in R2-1912001). Therefore, ‘Data in Msg4’ was specified as the LTE solution. Note that, for NB-IoT and LTE-M, different solutions were introduced for the IoT control-plane optimization (‘Data over NAS’, or DoNAS) and IoT user-plane optimizations (RRC suspend/resume), Control Plane EDT (CP-EDT), and User Plane EDT (UP-EDT), respectively, and that the NR solutions resembles the UP-EDT.

Currently MT-SDT is being introduced in Rel-18 for NR. A Rel-18 MT-SDT work item description (WID) was approved in RAN #94e (December 2021) and can be found in RP-213583. The WID contains the following objectives:
Specify the support for paging-triggered SDT (MT-SDT) [RAN2, RAN3]
   MT-SDT triggering mechanism for UEs in RRC_INACTIVE, supporting RA-SDT and CG-SDT as the UL response;
   MT-SDT procedure for initial DL data reception and subsequent UL/DL data transmissions in RRC_INACTIVE.
Note: Data transmission in DL within paging message is not in scope of this WI.

The Small Data Transmission (SDT) procedure in NR Rel-17 is only for MO-SDT meaning that it is only triggered by uplink (UL) data transmissions.

The CG-SDT procedure means that, after a UE has been directed to RRC_INACTIVE state, it will have a number of occasions pre-scheduled on the Physical Uplink Shared Channel (PUSCH) for a possible UL transmission. The UE will not monitor any control channel, only the paging channel. The scheduling occasions will be valid for the UE with a configured interval and as long as the time alignment timer is not expired. When the UE initiates a CG-SDT procedure, the UE transmits the data and RRCResumeRequest on a CG-SDT resource. When the NR base station (gNB) receives this transmission, it will acknowledge the transmission by sending a grant to the UE. The UE may use the grant to transmit any remaining data. However, if no grant is received, the UE is not allowed to transmit any new data on the CG resources. Instead, the UE will retransmit the already transmitted data and RRCResumeRequest message on the next CG-SDT resource. The reason for this is that the gNB needs to know that the UE has started the CG-SDT procedure. This behavior of autonomous retransmission of the initial transmission on CG resources is also an argument against configuring long CG periodicities: it will make the procedure sensitive to transmission failures of the initial transmission.

### SUMMARY

Systems and methods are disclosed for random access during Configured Grant (CG) Small Data Transmission (SDT). In one embodiment, a method performed by a User Equipment (UE) comprises, while in an inactive state, transmitting, to a network node, a Radio Resource Control (RRC) Resume Request with first data using a CG occasion from among a plurality of CG occasions configured for the UE and determining that one or more criteria for performing a Random Access (RA) have been satisfied. The method further comprises, responsive to determining that the one or more criteria for performing a RA have been satisfied, performing a RA during which the UE retransmits the RRC Resume Request with the first data. In this manner, the UE does not have to wait for the next CG occasion to send a retransmission or time critical data, e.g., in the case of failure of the initial transmission.

In one embodiment, the one or more criteria for performing the RA comprise a criterion that an amount of time until a next CG occasion from among the plurality of CG occasions is greater than a certain amount of time. In one embodiment, the criterion is a criterion that an amount of time until a next valid CG occasion from among the plurality of CG occasions is greater than a certain amount of time. In one embodiment, the next valid CG occasion is a next CG occasion with a same Synchronization Signal Block (SSB) association as the CG occasion in which the RRC Resume Request with the first data was transmitted or a CG occasion with an SSB association where the SSB Reference Signal Received Power (RSRP) is above a certain threshold.

In one embodiment, the one or more criteria for performing the RA comprise a criterion that a response to the RRC Resume Request has not been received from the network node within a certain amount of time. In one embodiment, the certain amount of time is a function of a periodicity of the plurality of CG occasions.

In one embodiment, the one or more criteria for performing the RA comprise a first criterion that a response to the RRC Resume Request has not been received from the network node within a first amount of time and a second criterion that an amount of time until a next CG occasion from among the plurality of CG occasions is greater than a second amount of time.

In one embodiment, the method further comprises, while in a connected state, receiving, from a network node, an RRC Release message comprising an CG-SDT configuration that configures the UE with the plurality of CG occasions and transitioning to the inactive state in response to receiving the RRC Release message. In one embodiment, the one or more criteria for performing the RA comprise: a first criterion that a response to the RRC Resume Request has not been received from the network node within a first amount of time, a second criterion that an amount of time until a next CG occasion from among the plurality of CG occasions is greater than a second amount of time, or both the first criterion and the second criterion. In one embodiment, the one or more criteria for performing the RA comprise the second criterion, and the second amount of time is defined by the CG-SDT configuration. In one embodiment, the second criterion is a criterion that an amount of time until a next valid CG occasion from among the plurality of CG occasions is greater than the second amount of time. In one embodiment, the next valid CG occasion is a next CG occasion with a same SSB association as the CG occasion in which the RRC Resume Request with the first data was transmitted or a CG occasion with an SSB association where the SSB RSRP is above a certain threshold.

In one embodiment, the one or more criteria for performing the RA comprise the first criterion, and the first amount of time is defined by the CG-SDT configuration.

In one embodiment, the plurality of CG occasions is configured for CG-SDT.

In one embodiment, the RA is a legacy RA, a RA-SDT, or a transmission using a RA-SDT resource.

In one embodiment, a subset of the plurality of CG occasions that occur in time after performing the RA cannot be used by the UE.

In one embodiment, a subset of the plurality of CG occasions that occur in time after performing the RA can be used by the UE.

In one embodiment, the one or more criteria for performing the RA comprise a criterion that additional data waiting for transmission at the UE has at least a certain priority. In one embodiment, the at least a certain priority is a least a certain Quality of Service (QoS) priority or at least a certain Logical Channel (LCH) priority.

In one embodiment, a transport block (TB) size of the data transmitted on the CG occasions matches a TB size of Msg3 of RA.

In one embodiment, a TB size of the data transmitted on the CG occasions does not match a TB size of Msg3 of RA, and a message carrying the data for the retransmission is rebuilt to have a TB size that matches the TB size of Msg3 of RA.

In one embodiment, a small data transmission failure timer is not restarted upon performing the RA to re-transmit the RRC Resume Request with the first data.

Corresponding embodiments of a UE are also disclosed. In one embodiment, a UE is adapted to, while in an inactive state, transmit, to a network node, a RRC Resume Request with first data using a CG occasion from among a plurality of CG occasions configured for the UE and determine that one or more criteria for performing a RA have been satisfied. The UE is further adapted to perform a RA during which the UE retransmits the RRC Resume Request with the first data, responsive to determining that the one or more criteria for performing a RA have been satisfied.

In another embodiment, a UE comprises a communication interface comprising a transmitter and a receiver, and processing circuitry associated with the communication interface. The processing circuitry is configured to cause the UE to, while in an inactive state, transmit, to a network node, a RRC Resume Request with first data using a CG occasion from among a plurality of CG occasions configured for the UE and determine that one or more criteria for performing a RA have been satisfied. The processing circuitry is further configured to cause the UE to perform a RA during which the UE retransmits the RRC Resume Request with the first data, responsive to determining that the one or more criteria for performing a RA have been satisfied.

Embodiments of a method performed by a network node are also disclosed. In one embodiment, a method performed by a network node comprises transmitting an RRC Release message to a UE, wherein the RRC Release message comprises a CG-SDT configuration that configures the UE with a plurality of CG occasions for CG-SDT and one or more parameters related to one or more criteria for the UE to perform RA for retransmission of a CG-SDT. The one or more criteria for the UE to perform RA for retransmission of a CG-SDT comprise a first criterion that a response to an RRC Resume Request with first data for a CG-SDT has not been received by the UE from the network node within a first amount of time, a second criterion that an amount of time until a next CG occasion from among the plurality of CG occasions is greater than a second amount of time, or both the first criterion and the second criterion.

In one embodiment, the one or more criteria for the UE to perform RA for retransmission of a CG-SDT comprise the second criterion. In one embodiment, the second criterion is a criterion that an amount of time until a next valid CG occasion from among the plurality of CG occasions is greater than the second amount of time. In one embodiment, the next valid CG occasion is a next CG occasion with a same SSB association as the CG occasion in which the RRC Resume Request with the first data was transmitted or a CG occasion with an SSB association where the SSB RSRP is above a certain threshold.

In one embodiment, the one or more criteria for the UE to perform RA for retransmission of a CG-SDT comprise the first criterion. In one embodiment, the first amount of time is a function of a periodicity of the plurality of CG occasions.

In one embodiment, the first amount of time is defined by the CG-SDT configuration, the second amount of time is defined by the CG-SDT configuration, or both the first amount of time and the second amount of time are defined by the CG-SDT configuration.

In one embodiment, the RA is a legacy RA, a RA-SDT, or a transmission using a RA-SDT resource.

In one embodiment, a subset of the plurality of CG occasions that occur in time after the UE performs the RA cannot be used by the UE.

In one embodiment, a subset of the plurality of CG occasions that occur in time after the UE performs the RA can be used by the UE.

In one embodiment, the one or more criteria for performing the RA further comprise a criterion that additional data waiting for transmission at the UE has at least a certain.

Corresponding embodiments of a network node are also disclosed. In one embodiment, a network node is adapted to transmit an RRC Release message to a UE, wherein the RRC Release message comprises a CG-SDT configuration that configures the UE with a plurality of CG occasions for CG-SDT and one or more parameters related to one or more criteria for the UE to perform RA for retransmission of a CG-SDT. The one or more criteria for the UE to perform RA for retransmission of a CG-SDT comprise a first criterion that a response to an RRC Resume Request with first data for a CG-SDT has not been received by the UE from the network node within a first amount of time, a second criterion that an amount of time until a next CG occasion from among the plurality of CG occasions is greater than a second amount of time, or both the first criterion and the second criterion.

In one embodiment, a network node comprises processing circuitry configured to cause the network node to transmit an RRC Release message to a UE, wherein the RRC Release message comprises a CG-SDT configuration that configures the UE with a plurality of CG occasions for CG-SDT and one or more parameters related to one or more criteria for the UE to perform RA for retransmission of a CG-SDT. The one or more criteria for the UE to perform RA for retransmission of a CG-SDT comprise a first criterion that a response to an RRC Resume Request with first data for a CG-SDT has not been received by the UE from the network node within a first amount of time, a second criterion that an amount of time until a next CG occasion from among the plurality of CG occasions is greater than a second amount of time, or both the first criterion and the second criterion.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a procedure in which a User Equipment (UE) that is configured for Configured Grant (CG) Small Data Transmission (SDT) is enabled to perform Random Access (RA) during an ongoing CG-SDT procedure under certain constraints, in accordance with an embodiment of the present disclosure;

FIG. 2 shows an example of a communication system in accordance with some embodiments;

FIG. 3 shows a UE in accordance with some embodiments;

FIG. 4 shows a network node in accordance with some embodiments;

FIG. 5 is a block diagram of a host, which may be an embodiment of the host of FIG. 2, in accordance with various aspects described herein;

FIG. 6 is a block diagram illustrating a virtualization environment in which functions implemented by some embodiments may be virtualized;

FIG. 7 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). If the New Radio (NR) base station (gNB) configures a Configured Grant (CG) Small Data Transmission (SDT) (CG-SDT) configuration for a User Equipment (UE), the gNB will reserve resources without any certain data being transmitted, leading to a potential waste of scheduling events. One way to counter this is to configure the UE with less frequent scheduling events. However, if the events are too far apart, a possible failure in the uplink (UL) transmission will result in that the next possible UL transmission will be delayed, resulting in poor latency and a bad user experience. Since the procedure has been designed so that only autonomous retransmissions of the initial transmission are possible, there is no possibility to recover from the transmission failure until the next CG occasion, and when this occurs depends on the periodicity. Another problem if the periodicity would be longer than the setting of the T319a timer (SDT failure timer) is that the procedure would be terminated before the next CG occasion meaning that there will not even be any opportunity to do a retransmission.

For this reason, the longest possible UL transmission periodicity was set to a number of symbols that translates to 640 milliseconds (ms). While 640 ms is a long time from a Radio Resource Control (RRC)/Medium Access Control (MAC) perspective, it is not such a long time from an application layer perspective. It has been argued that a longer periodicity is necessary to have gains with CG-SDT, so the UE can be ready to perform CG-SDT for a longer time, while not consuming resources at the gNB side at such a frequency. This would be especially useful for low prioritized access UEs that do not have high performance requirements.

The problem in 3^{rd} Generation Partnership Project (3GPP) release 17 is that CG-SDT relies on quite frequent periodicity which keeps the network from assigning it to a CG-SDT configuration for any significant amount of time. Further, companies are hesitant to introduce longer periodicity since the end user performance could be affected.

Certain aspects of the disclosure and their embodiments may provide solutions to these or other challenges. Systems and methods are disclosed herein that introduce an opportunity for a UE in CG-SDT configuration to perform a random access or Random Access SDT (RA-SDT) procedure during an ongoing CG-SDT procedure under some constraints. The constraints of performing random access might include, but are not limited to:
The initial transmission of the RRCResumeRequest and first data has been performed and
   No new grant has been received, and
   A specified time has elapsed since the transmission and
   Optionally, the time until the next CG occasion is larger than a second specific time.

The random access procedure may be legacy Random Access (RA) procedure, a RA-SDT procedure, or using the RA-SDT resources to retransmit the RRCResumeRequest and first data for which no acknowledgement was received.

In one embodiment, functionality is introduced into a 3GPP system (e.g., in the 3GPP specifications) to allow a UE to make a random access during an ongoing CG procedure when no response to the initial transmission has been received.

Certain embodiments may provide one or more of the following technical advantage(s):
Longer periodicity for CG occasions can be introduced, thus adding benefit to the CG-SDT feature;
Shorter latency of the CG-SDT procedure in case the initial transmission fails;
The UE does not have to wait for the next CG occasion to send a retransmission;
The UE does not have to wait for the next CG occasion to send time critical data.

The reason for performing a Random Access while still having CG occasions in the future could be that a retransmission of data is necessary and the periodicity makes the CG occasion occur too far in the future, or that the UE has new data in its uplink (UL) buffer that is regarded as time critical and cannot wait for the next occasion.

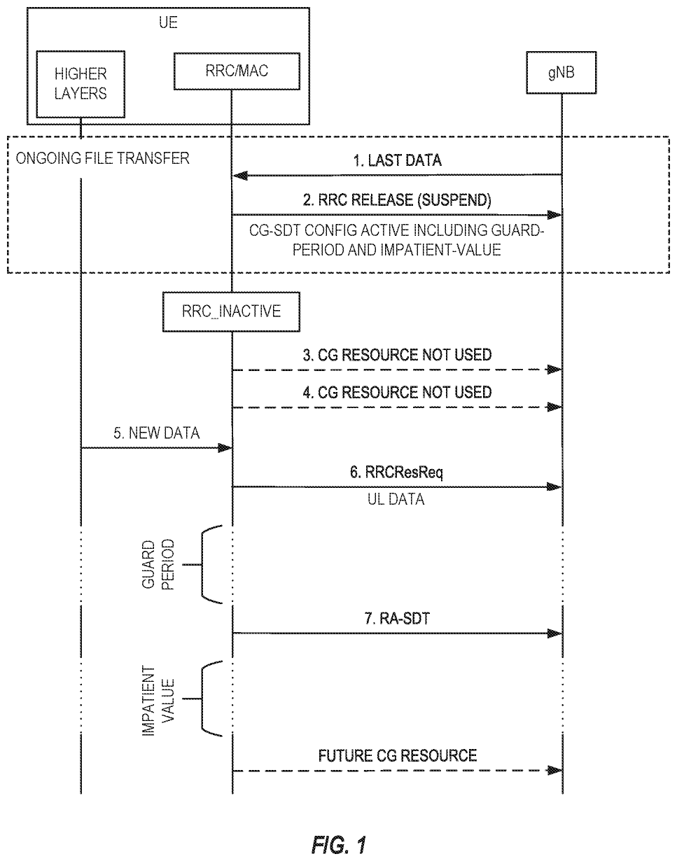

In one embodiment, a UE is configured (e.g., by a network node such as, e.g., a gNB) to either allow or not allow the UE to trigger RA when no response has been received to an initial transmission (e.g., an initial transmission on a CG occasion such as, e.g., one of multiple CG occasions configured for CG-SDT). The configuration may specify a minimum time after the initial transmission when RA may be triggered when no response has been received, e.g. a guard period described as step 2 and 7 in FIG. 1 (described below). This may be implemented as a timer which is started when the initial transmission is performed. When the timer expires and no response has been received, RA can be triggered. The timer setting may be a function of the CG periodicity or a configured value. The time may also be a number of Physical Downlink Control Channel (PDCCH) monitoring occasions after the initial transmission.

A minimum time until the next valid CG transmission occasion may also be configured when RA may be triggered, referred to as “impatient value” in step 2 and 8 in FIG. 1. For example, a RA procedure may be triggered if the next valid CG occasion is at least “x” ms away, where “x” is preferably a non-zero positive value. The next valid CG occasion may be the first CG occasion with the same Synchronization Signal Block (SSB) association as the CG occasion where the initial transmission was carried out, or a CG occasion with an SSB association where the SSB Reference Signal Received Power (RSRP) is above a threshold. In addition to this, there could also be cases where the UE has an opportunity for successful transmission within the same CG occasion after SSB re-selection. Tracking the impatient value allows triggering RA-SDT after all the possibilities for successful transmission within the ongoing CG occasion have been exhausted.

In one embodiment, the CG-SDT resources may not be used once the UE has transmitted the RRCResumeRequest on RA resources. This may be the case when the CG-SDT resources may be shared by several UEs within the cell. In another aspect of this embodiment, the UE can continue to use the CG-SDT resources even after the RRCResumeRequest has been transmitted on RA resources. This may be advantageous if there is no response to the RRCResumeRequest transmitted on the RA resource and there is an upcoming CG-SDT resource that can be used for yet another retransmission of the RRCResumeRequest.

It may also be configured that RA may be triggered when no response has been received to the initial CG-transmission if the data has certain priorities, e.g., Quality of Service (QoS) characteristic or Logical Channel (LCH) priority.

These configurations may be provided in System Information (SI) or in the RRCRelease message which provides the CG-SDT configuration as described in step 2 in FIG. 1.

In one embodiment, the RA resources which are allowed are RA-SDT resources. In another aspect of this embodiment, the RA resources which are allowed are legacy RA resources. In yet another aspect of this embodiment, both RA-SDT and legacy RA resources can be used. However, there can be a restriction in using only legacy RA resources for CG-SDT UEs that do not support RA-SDT (CG-SDT and RA-SDT capabilities are considered independent). Therefore, in an alternate embodiment, the gNB takes into account the UE capability, and provides RA-SDT resources for UEs supporting RA-SDT, while providing legacy RA resources for UEs that do not support RA-SDT.

In one embodiment, the transport block (TB) size of the CG-SDT matches the TB size of msg3, so an exact retransmission may be done of the RRCResumeRequest message and the data. In case a different TB size is configured for msg3 in the RA procedure, the message can be rebuilt to fit the new TB size.

In one embodiment, the T319a timer is not restarted so the same SDT procedure is ongoing from the UE point of view. In one aspect of this embodiment, an indicator is included in the message to enable the gNB to identify that the T319a timer is not restarted. In another aspect of this embodiment, the T319a timer is restarted when the retransmission is done. In this case a transmission counter can be specified to limit the number of retransmission attempts that can be used by the UE, i.e. a maximum number of transmission attempts is specified (since in this case, the T319a timer will never expire).

Now, FIG. 1 will be described. In the example of FIG. 1, a prerequisite for one embodiment of the present disclosure is that the UE has transferred into RRC_INACTIVE with a valid CG-SDT configuration. In other words, as illustrated in FIG. 1, after receiving the last data for an ongoing file transfer (step 1), the UE receives, from the gNB, an RRCRelease message that includes a valid CG-SDT configuration (step 2). The CG-SDT configuration includes uplink transmit occasions (also referred to herein as CG occasions or CG resources) that the UE can use for CG-SDT if the UE has data available. The CG-SDT configuration also includes, in one embodiment, information that defines the guard time and/or information that indicates the impatient time. Responsive to receiving the RRC Release message, the UE transitions from the RRC CONNECTED state to the RRC INACTIVE state.

While in the RRC INACTIVE state, in the described example, a few CG occasions pass where the UE does not have any data available for transmission (steps 3 and 4). However, some first data arrives at an RCC/MAC instance from higher layers (step 5), and the UE follows the CG-SDT procedure and sends an RRC Resume Request along with the first data that arrived at the MAC instance (step 6). After sending the RRC Resume Request along with the first data, the UE determines that one or more criteria for RA are satisfied, where these one or more criteria include a first criterion that no response is received from the gNB within a specified amount of time, which is referred to here as a guard period. This guard period may be configured via the CG-SDT configuration, otherwise configured by the network (e.g., gNB), defined (e.g., by 3GPP specification), or the like. In another embodiment, the guard period is a function of the periodicity of the CG occasions defined by the CG-SDT configuration. The one or more criteria for performing RA may including one or more additional criteria such as, e.g.: (a) a criterion that there is additional data ready for UL transmission, (b) the amount of time until the next CG occasion is greater than a second amount of time (referred to here as the impatience time), (c) the data waiting to be transmitted meets one or more criteria (e.g., priority such as, e.g., QoS priority or LCH priority, is greater than a defined or configured threshold), or (d) any combination of two or more of (a)-(c). In regard to the impatience time, the impatience time may, e.g., be indicated by the CG-SDT configuration, otherwise configured by the network (e.g., by the gNB), defined (e.g., via 3GPP specification), or the like.

Responsive to sending the RRC Resume Request along with the first data and determining that the one or more criteria for performing RA are satisfied, the UE performs a RA (e.g., a legacy RA, a RA-SDT, or using defined or configured RA-SDT resources) to retransmit the RRC Resume Request and the first data. In the illustrated example, the UE performs a RA-SDT including a retransmission of the RRC Resume Request and the first data (step 7).

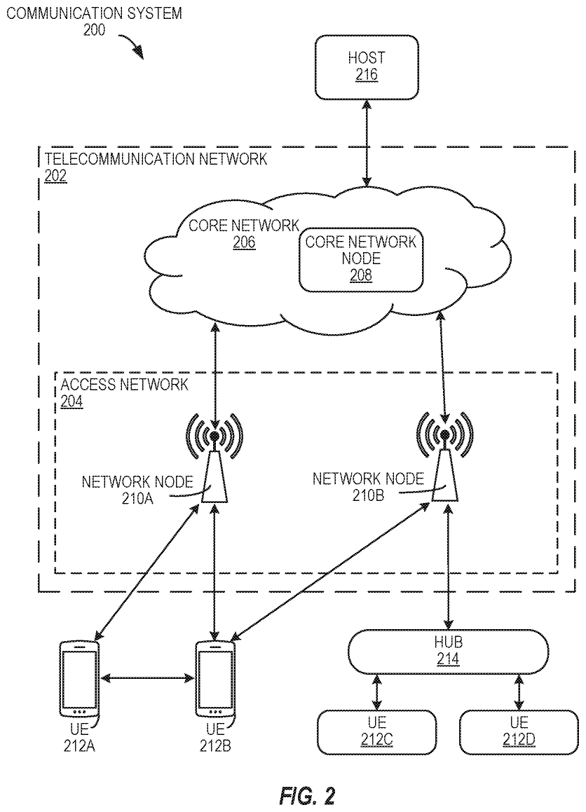

FIG. 2 shows an example of a communication system 200 in accordance with some embodiments.

In the example, the communication system 200 includes a telecommunication network 202 that includes an access network 204, such as a Radio Access Network (RAN), and a core network 206, which includes one or more core network nodes 208. The access network 204 includes one or more access network nodes, such as network nodes 210A and 210B (one or more of which may be generally referred to as network nodes 210), or any other similar Third Generation Partnership Project (3GPP) access node or non-3GPP Access Point (AP). The network nodes 210 facilitate direct or indirect connection of User Equipment (UE), such as by connecting UEs 212A, 212B, 212C, and 212D (one or more of which may be generally referred to as UEs 212) to the core network 206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 200 may include any number of wired or wireless networks, network nodes, UEs, and/or any other components or systems that may facilitate or participate in the communication of data and/or signals whether via wired or wireless connections. The communication system 200 may include and/or interface with any type of communication, telecommunication, data, cellular, radio network, and/or other similar type of system.

The UEs 212 may be any of a wide variety of communication devices, including wireless devices arranged, configured, and/or operable to communicate wirelessly with the network nodes 210 and other communication devices. Similarly, the network nodes 210 are arranged, capable, configured, and/or operable to communicate directly or indirectly with the UEs 212 and/or with other network nodes or equipment in the telecommunication network 202 to enable and/or provide network access, such as wireless network access, and/or to perform other functions, such as administration in the telecommunication network 202.

In the depicted example, the core network 206 connects the network nodes 210 to one or more hosts, such as host 216. These connections may be direct or indirect via one or more intermediary networks or devices. In other examples, network nodes may be directly coupled to hosts. The core network 206 includes one more core network nodes (e.g., core network node 208) that are structured with hardware and software components. Features of these components may be substantially similar to those described with respect to the UEs, network nodes, and/or hosts, such that the descriptions thereof are generally applicable to the corresponding components of the core network node 208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 216 may be under the ownership or control of a service provider other than an operator or provider of the access network 204 and/or the telecommunication network 202, and may be operated by the service provider or on behalf of the service provider. The host 216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 200 of FIG. 2 enables connectivity between the UEs, network nodes, and hosts. In that sense, the communication system 200 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 202 is a cellular network that implements 3GPP standardized features. Accordingly, the telecommunication network 202 may support network slicing to provide different logical networks to different devices that are connected to the telecommunication network 202. For example, the telecommunication network 202 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 212 are configured to transmit and/or receive information without direct human interaction. For instance, a UE may be designed to transmit information to the access network 204 on a predetermined schedule, when triggered by an internal or external event, or in response to requests from the access network 204. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 214 communicates with the access network 204 to facilitate indirect communication between one or more UEs (e.g., UE 212C and/or 212D) and network nodes (e.g., network node 210B). In some examples, the hub 214 may be a controller, router, content source and analytics, or any of the other communication devices described herein regarding UEs. For example, the hub 214 may be a broadband router enabling access to the core network 206 for the UEs. As another example, the hub 214 may be a controller that sends commands or instructions to one or more actuators in the UEs. Commands or instructions may be received from the UEs, network nodes 210, or by executable code, script, process, or other instructions in the hub 214. As another example, the hub 214 may be a data collector that acts as temporary storage for UE data and, in some embodiments, may perform analysis or other processing of the data. As another example, the hub 214 may be a content source. For example, for a UE that is a Virtual Reality (VR) headset, display, loudspeaker or other media delivery device, the hub 214 may retrieve VR assets, video, audio, or other media or data related to sensory information via a network node, which the hub 214 then provides to the UE either directly, after performing local processing, and/or after adding additional local content. In still another example, the hub 214 acts as a proxy server or orchestrator for the UEs, in particular in if one or more of the UEs are low energy IoT devices.

The hub 214 may have a constant/persistent or intermittent connection to the network node 210B. The hub 214 may also allow for a different communication scheme and/or schedule between the hub 214 and UEs (e.g., UE 212C and/or 212D), and between the hub 214 and the core network 206. In other examples, the hub 214 is connected to the core network 206 and/or one or more UEs via a wired connection. Moreover, the hub 214 may be configured to connect to a Machine-to-Machine (M2M) service provider over the access network 204 and/or to another UE over a direct connection. In some scenarios, UEs may establish a wireless connection with the network nodes 210 while still connected via the hub 214 via a wired or wireless connection. In some embodiments, the hub 214 may be a dedicated hub—that is, a hub whose primary function is to route communications to/from the UEs from/to the network node 210B. In other embodiments, the hub 214 may be a non-dedicated hub—that is, a device which is capable of operating to route communications between the UEs and the network node 210B, but which is additionally capable of operating as a communication start and/or end point for certain data channels.

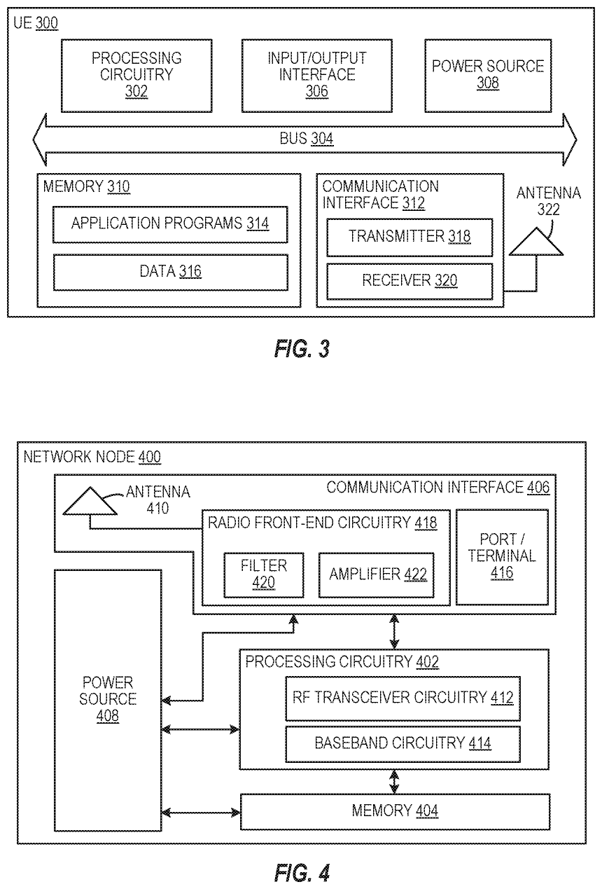

FIG. 3 shows a UE 300 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 302 may include multiple Central Processing Units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging the power source 308. Power circuitry may perform any formatting, converting, or other modification to the power from the power source 308 to make the power suitable for the respective components of the UE 300 to which power is supplied.

The memory 310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 310 may allow the UE 300 to access instructions, application programs, and the like stored on transitory or non-transitory memory media, to off-load data, or to upload data. An article of manufacture, such as one utilizing a communication system, may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., the antenna 322) and may share circuit components, software, or firmware, or alternatively be implemented separately.

In the illustrated embodiment, communication functions of the communication interface 312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 312, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 300 shown in FIG. 3.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 4 shows a network node 400 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 400 includes processing circuitry 402, memory 404, a communication interface 406, and a power source 408. The network node 400 may be composed of multiple physically separate components (e.g., a Node B component and an RNC component, or a BTS component and a BSC component, etc.), which may each have their own respective components. In certain scenarios in which the network node 400 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 400 may be configured to support multiple RATs. In such embodiments, some components may be duplicated (e.g., separate memory 404 for different RATs) and some components may be reused (e.g., an antenna 410 may be shared by different RATs). The network node 400 may also include multiple sets of the various illustrated components for different wireless technologies integrated into network node 400, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 400.

The processing circuitry 402 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 400 components, such as the memory 404, to provide network node 400 functionality.

In some embodiments, the processing circuitry 402 includes a System on a Chip (SOC). In some embodiments, the processing circuitry 402 includes one or more of Radio Frequency (RF) transceiver circuitry 412 and baseband processing circuitry 414. In some embodiments, the RF transceiver circuitry 412 and the baseband processing circuitry 414 may be on separate chips (or sets of chips), boards, or units, such as radio units and digital units. In alternative embodiments, part or all of the RF transceiver circuitry 412 and the baseband processing circuitry 414 may be on the same chip or set of chips, boards, or units.

The memory 404 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 402. The memory 404 may store any suitable instructions, data, or information, including a computer program, software, an application including one or more of logic, rules, code, tables, and/or other instructions capable of being executed by the processing circuitry 402 and utilized by the network node 400. The memory 404 may be used to store any calculations made by the processing circuitry 402 and/or any data received via the communication interface 406. In some embodiments, the processing circuitry 402 and the memory 404 are integrated.

The communication interface 406 is used in wired or wireless communication of signaling and/or data between a network node, access network, and/or UE. As illustrated, the communication interface 406 comprises port(s)/terminal(s) 416 to send and receive data, for example to and from a network over a wired connection. The communication interface 406 also includes radio front-end circuitry 418 that may be coupled to, or in certain embodiments a part of, the antenna 410. The radio front-end circuitry 418 comprises filters 420 and amplifiers 422. The radio front-end circuitry 418 may be connected to the antenna 410 and the processing circuitry 402. The radio front-end circuitry 418 may be configured to condition signals communicated between the antenna 410 and the processing circuitry 402. The radio front-end circuitry 418 may receive digital data that is to be sent out to other network nodes or UEs via a wireless connection. The radio front-end circuitry 418 may convert the digital data into a radio signal having the appropriate channel and bandwidth parameters using a combination of the filters 420 and/or the amplifiers 422. The radio signal may then be transmitted via the antenna 410. Similarly, when receiving data, the antenna 410 may collect radio signals which are then converted into digital data by the radio front-end circuitry 418. The digital data may be passed to the processing circuitry 402. In other embodiments, the communication interface 406 may comprise different components and/or different combinations of components.

In certain alternative embodiments, the network node 400 does not include separate radio front-end circuitry 418; instead, the processing circuitry 402 includes radio front-end circuitry and is connected to the antenna 410. Similarly, in some embodiments, all or some of the RF transceiver circuitry 412 is part of the communication interface 406. In still other embodiments, the communication interface 406 includes the one or more ports or terminals 416, the radio front-end circuitry 418, and the RF transceiver circuitry 412 as part of a radio unit (not shown), and the communication interface 406 communicates with the baseband processing circuitry 414, which is part of a digital unit (not shown).

The antenna 410 may include one or more antennas, or antenna arrays, configured to send and/or receive wireless signals. The antenna 410 may be coupled to the radio front-end circuitry 418 and may be any type of antenna capable of transmitting and receiving data and/or signals wirelessly. In certain embodiments, the antenna 410 is separate from the network node 400 and connectable to the network node 400 through an interface or port.

The antenna 410, the communication interface 406, and/or the processing circuitry 402 may be configured to perform any receiving operations and/or certain obtaining operations described herein as being performed by the network node 400. Any information, data, and/or signals may be received from a UE, another network node, and/or any other network equipment. Similarly, the antenna 410, the communication interface 406, and/or the processing circuitry 402 may be configured to perform any transmitting operations described herein as being performed by the network node 400. Any information, data, and/or signals may be transmitted to a UE, another network node, and/or any other network equipment.

The power source 408 provides power to the various components of the network node 400 in a form suitable for the respective components (e.g., at a voltage and current level needed for each respective component). The power source 408 may further comprise, or be coupled to, power management circuitry to supply the components of the network node 400 with power for performing the functionality described herein. For example, the network node 400 may be connectable to an external power source (e.g., the power grid or an electricity outlet) via input circuitry or an interface such as an electrical cable, whereby the external power source supplies power to power circuitry of the power source 408. As a further example, the power source 408 may comprise a source of power in the form of a battery or battery pack which is connected to, or integrated in, power circuitry. The battery may provide backup power should the external power source fail.

Embodiments of the network node 400 may include additional components beyond those shown in FIG. 4 for providing certain aspects of the network node's functionality, including any of the functionality described herein and/or any functionality necessary to support the subject matter described herein. For example, the network node 400 may include user interface equipment to allow input of information into the network node 400 and to allow output of information from the network node 400. This may allow a user to perform diagnostic, maintenance, repair, and other administrative functions for the network node 400.

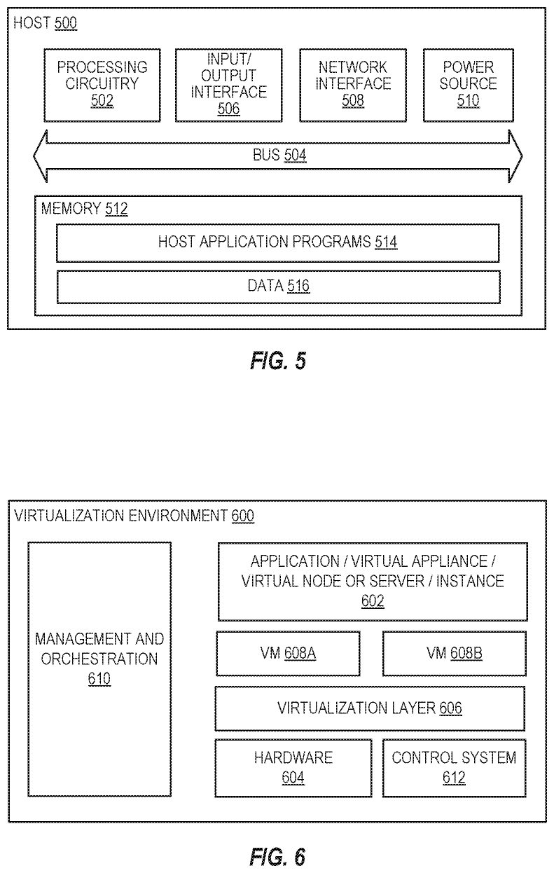

FIG. 5 is a block diagram of a host 500, which may be an embodiment of the host 216 of FIG. 2, in accordance with various aspects described herein. As used herein, the host 500 may be or comprise various combinations of hardware and/or software including a standalone server, a blade server, a cloud-implemented server, a distributed server, a virtual machine, container, or processing resources in a server farm. The host 500 may provide one or more services to one or more UEs.

The host 500 includes processing circuitry 502 that is operatively coupled via a bus 504 to an input/output interface 506, a network interface 508, a power source 510, and memory 512. Other components may be included in other embodiments. Features of these components may be substantially similar to those described with respect to the devices of previous figures, such as FIGS. 3 and 4, such that the descriptions thereof are generally applicable to the corresponding components of the host 500.

The memory 512 may include one or more computer programs including one or more host application programs 514 and data 516, which may include user data, e.g. data generated by a UE for the host 500 or data generated by the host 500 for a UE. Embodiments of the host 500 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 514 may also provide for user authentication and licensing checks and may periodically report health, routes, and content availability to a central node, such as a device in or on the edge of a core network. Accordingly, the host 500 may select and/or indicate a different host for Over-The-Top (OTT) services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

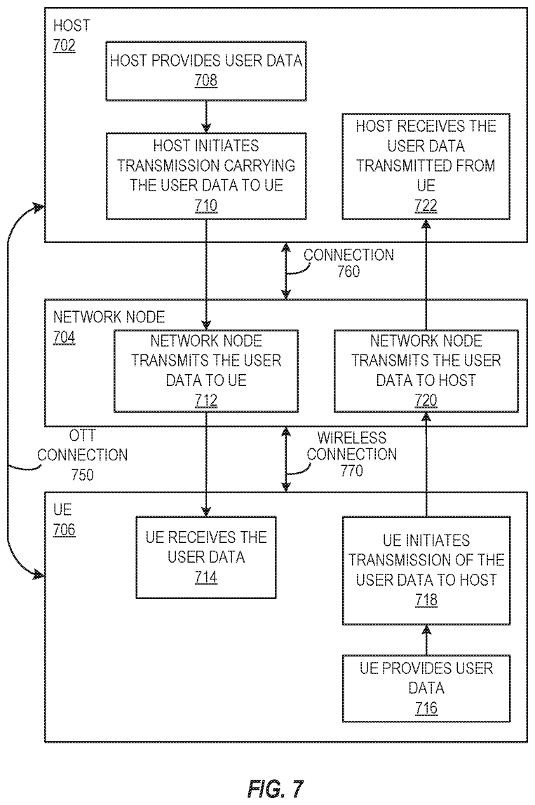

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 602 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or VM Monitors (VMMs)), provide VMs 608A and 608B (one or more of which may be generally referred to as VMs 608), and/or perform any of the functions, features, and/or benefits described in relation with some embodiments described herein. The virtualization layer 606 may present a virtual operating platform that appears like networking hardware to the VMs 608.

The VMs 608 comprise virtual processing, virtual memory, virtual networking, or interface and virtual storage, and may be run by a corresponding virtualization layer 606. Different embodiments of the instance of a virtual appliance 602 may be implemented on one or more of the VMs 608, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 608 may be a software implementation of a physical machine that runs programs as if they were executing on a physical, non-virtualized machine. Each of the VMs 608, and that part of the hardware 604 that executes that VM, be it hardware dedicated to that VM and/or hardware shared by that VM with others of the VMs 608, forms separate virtual network elements. Still in the context of NFV, a virtual network function is responsible for handling specific network functions that run in one or more VMs 608 on top of the hardware 604 and corresponds to the application 602.

The hardware 604 may be implemented in a standalone network node with generic or specific components. The hardware 604 may implement some functions via virtualization. Alternatively, the hardware 604 may be part of a larger cluster of hardware (e.g., such as in a data center or CPE) where many hardware nodes work together and are managed via management and orchestration 610, which, among others, oversees lifecycle management of the applications 602. In some embodiments, the hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 612 which may alternatively be used for communication between hardware nodes and radio units.

FIG. 7 shows a communication diagram of a host 702 communicating via a network node 704 with a UE 706 over a partially wireless connection in accordance with some embodiments. Example implementations, in accordance with various embodiments, of the UE (such as the UE 212A of FIG. 2 and/or the UE 300 of FIG. 3), the network node (such as the network node 210A of FIG. 2 and/or the network node 400 of FIG. 4), and the host (such as the host 216 of FIG. 2 and/or the host 500 of FIG. 5) discussed in the preceding paragraphs will now be described with reference to FIG. 7.

Like the host 500, embodiments of the host 702 include hardware, such as a communication interface, processing circuitry, and memory. The host 702 also includes software, which is stored in or is accessible by the host 702 and executable by the processing circuitry. The software includes a host application that may be operable to provide a service to a remote user, such as the UE 706 connecting via an OTT connection 750 extending between the UE 706 and the host 702. In providing the service to the remote user, a host application may provide user data which is transmitted using the OTT connection 750.

The network node 704 includes hardware enabling it to communicate with the host 702 and the UE 706 via a connection 760. The connection 760 may be direct or pass through a core network (like the core network 206 of FIG. 2) and/or one or more other intermediate networks, such as one or more public, private, or hosted networks. For example, an intermediate network may be a backbone network or the Internet.

The UE 706 includes hardware and software, which is stored in or accessible by the UE 706 and executable by the UE's processing circuitry. The software includes a client application, such as a web browser or operator-specific “app” that may be operable to provide a service to a human or non-human user via the UE 706 with the support of the host 702. In the host 702, an executing host application may communicate with the executing client application via the OTT connection 750 terminating at the UE 706 and the host 702. In providing the service to the user, the UE's client application may receive request data from the host's host application and provide user data in response to the request data. The OTT connection 750 may transfer both the request data and the user data. The UE's client application may interact with the user to generate the user data that it provides to the host application through the OTT connection 750.

The OTT connection 750 may extend via the connection 760 between the host 702 and the network node 704 and via a wireless connection 770 between the network node 704 and the UE 706 to provide the connection between the host 702 and the UE 706. The connection 760 and the wireless connection 770, over which the OTT connection 750 may be provided, have been drawn abstractly to illustrate the communication between the host 702 and the UE 706 via the network node 704, without explicit reference to any intermediary devices and the precise routing of messages via these devices.

As an example of transmitting data via the OTT connection 750, in step 708, the host 702 provides user data, which may be performed by executing a host application. In some embodiments, the user data is associated with a particular human user interacting with the UE 706. In other embodiments, the user data is associated with a UE 706 that shares data with the host 702 without explicit human interaction. In step 710, the host 702 initiates a transmission carrying the user data towards the UE 706. The host 702 may initiate the transmission responsive to a request transmitted by the UE 706. The request may be caused by human interaction with the UE 706 or by operation of the client application executing on the UE 706. The transmission may pass via the network node 704 in accordance with the teachings of the embodiments described throughout this disclosure. Accordingly, in step 712, the network node 704 transmits to the UE 706 the user data that was carried in the transmission that the host 702 initiated, in accordance with the teachings of the embodiments described throughout this disclosure. In step 714, the UE 706 receives the user data carried in the transmission, which may be performed by a client application executed on the UE 706 associated with the host application executed by the host 702.

In some examples, the UE 706 executes a client application which provides user data to the host 702. The user data may be provided in reaction or response to the data received from the host 702. Accordingly, in step 716, the UE 706 may provide user data, which may be performed by executing the client application. In providing the user data, the client application may further consider user input received from the user via an input/output interface of the UE 706. Regardless of the specific manner in which the user data was provided, the UE 706 initiates, in step 718, transmission of the user data towards the host 702 via the network node 704. In step 720, in accordance with the teachings of the embodiments described throughout this disclosure, the network node 704 receives user data from the UE 706 and initiates transmission of the received user data towards the host 702. In step 722, the host 702 receives the user data carried in the transmission initiated by the UE 706.

One or more of the various embodiments improve the performance of OTT services provided to the UE 706 using the OTT connection 750, in which the wireless connection 770 forms the last segment. More precisely, the teachings of these embodiments may improve latency and thereby provide benefits such as, e.g., reduced user waiting time, better responsiveness, etc.

In an example scenario, factory status information may be collected and analyzed by the host 702. As another example, the host 702 may process audio and video data which may have been retrieved from a UE for use in creating maps. As another example, the host 702 may collect and analyze real-time data to assist in controlling vehicle congestion (e.g., controlling traffic lights). As another example, the host 702 may store surveillance video uploaded by a UE. As another example, the host 702 may store or control access to media content such as video, audio, VR, or AR which it can broadcast, multicast, or unicast to UEs. As other examples, the host 702 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 750 between the host 702 and the UE 706 in response to variations in the measurement results. The measurement procedure and/or the network functionality for reconfiguring the OTT connection 750 may be implemented in software and hardware of the host 702 and/or the UE 706. In some embodiments, sensors (not shown) may be deployed in or in association with other devices through which the OTT connection 750 passes; the sensors may participate in the measurement procedure by supplying values of the monitored quantities exemplified above, or by supplying values of other physical quantities from which software may compute or estimate the monitored quantities. The reconfiguring of the OTT connection 750 may include message format, retransmission settings, preferred routing, etc.; the reconfiguring need not directly alter the operation of the network node 704. Such procedures and functionalities may be known and practiced in the art. In certain embodiments, measurements may involve proprietary UE signaling that facilitates measurements of throughput, propagation times, latency, and the like by the host 702. The measurements may be implemented in that software causes messages to be transmitted, in particular empty or ‘dummy’ messages, using the OTT connection 750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by computing device as a whole and/or by end users and a wireless network generally.

Some example embodiments of the present disclosure are as follows:

### GROUP A EMBODIMENTS

Embodiment 1: A method performed by a user equipment, UE, the method comprising, while in an inactive state:
transmitting (FIG. 1, step 6), to a network node (e.g., a gNB), an RRC Resume Request with first data using a CG occasion from among a plurality of CG occasions configured for the UE;
determining (FIG. 1, step 7) that one or more criteria for performing a RA have been satisfied, the one or more criteria comprising a first criterion that a response to the RRC Resume Request has not been received from the network node within a first amount of time;
responsive to determining (FIG. 1, step 7) that the one or more criteria for performing a RA have been satisfied, performing (FIG. 1, step 7) a RA during which the UE retransmits the RRC Resume Request with the first data.

Embodiment 2: The method of embodiment 1 further comprising: while in a connected state, receiving (FIG. 1, step 2), from a network node (e.g., gNB), an RRC Release message comprising an CG-SDT configuration that configures the UE with the plurality of CG occasions; and transitioning (FIG. 1, step 2) to an inactive state in response to receiving (FIG. 1, step 2) the RRC Release message.

Embodiment 3: The method of embodiment 2 wherein the first amount of time is defined by the CG-SDT configuration.

Embodiment 4: The method of embodiment 2 or 3 wherein the one or more criteria performing the RA further comprise a second criterion that an amount of time until a next CG occasion from among the plurality of CG occasions is greater than a second amount of time, and second amount of time is defined by the CG-SDT configuration.

Embodiment 5: The method of any of embodiments 1 to 3 wherein the one or more criteria for performing the RA further comprise a second criterion that an amount of time until a next CG occasion from among the plurality of CG occasions is greater than a second amount of time.

Embodiment 6: The method of any of embodiments 1 to 5 wherein the plurality of CG occasions are configured for CG-SDT.

Embodiment 7: The method of any of embodiments 1, 2, or 6 wherein the first amount of time is a function of a periodicity of the plurality of CG occasions.

Embodiment 8: The method of any of embodiments 1 to 7 wherein the RA is a legacy RA, a RA-SDT, or a transmission using a RA-SDT resource.

Embodiment 9: The method of any of embodiments 1 to 8 wherein a subset of the plurality of CG occasions that occur in time after performing the RA cannot be used by the UE.

Embodiment 10: The method of any of embodiments 1 to 8 wherein a subset of the plurality of CG occasions that occur in time after performing the RA can be used by the UE.

Embodiment 11: The method of any of embodiments 1 to 10 wherein the one or more criteria for performing the RA further comprise a criterion that additional data waiting for transmission at the UE has at least a certain priority (e.g., at least a certain QoS priority or at least a LCH priority).

Embodiment 12: The method of any of embodiments 1 to 11 wherein a TB size of the data transmitted on the CG occasions (e.g., the TB size of the respective CG-SDT) matches a TB size of Msg3 of RA.

Embodiment 13: The method of any of embodiments 1 to 11 wherein a TB size of the data transmitted on the CG occasions (e.g., the TB size of the respective CG-SDT) does not match a TB size of Msg3 of RA, and a message carrying the data for the retransmission is rebuilt to have a TB size that matches the TB size of Msg3 of RA.

Embodiment 14: The method of any of embodiments 1 to 13 wherein a T319a timer is not restarted (e.g., not restarted upon performing the RA to re-transmit the RRC Resume Request with the first data).

Embodiment 15: The method of any of the previous embodiments, further comprising: providing user data; and forwarding the user data to a host via the transmission to the network node.

### GROUP B EMBODIMENTS

Embodiment 16: A method performed by a network node, the method comprising: transmitting (FIG. 1, step 2), to a UE, an RRC Release message comprising an CG-SDT configuration that configures the UE with the plurality of CG occasions for CG-SDT and one or more parameters related to one or more criteria for the UE to perform RA for retransmission of a CG-SDT; wherein the one or more criteria for the UE to perform RA for retransmission of a CG-SDT comprises a first criterion that a response to an RRC Resume Request with first data for a CG-SDT has not been received by the UE from the network node within a first amount of time.

Embodiment 17: The method of embodiment 16 wherein the one or more criteria for the UE to perform RA for retransmission of a CG-SDT further comprise a second criterion that an amount of time until a next CG occasion from among the plurality of CG occasions is greater than a second amount of time.

Embodiment 18: The method of embodiment 17 wherein the second amount of time is defined by the CG-SDT configuration.

Embodiment 19: The method of any of embodiments 16 to 18 wherein the RA is a legacy RA, a RA-SDT, or a transmission using a RA-SDT resource.

Embodiment 20: The method of any of embodiments 16 to 19 wherein a subset of the plurality of CG occasions that occur in time after the UE performs the RA cannot be used by the UE.

Embodiment 21: The method of any of embodiments 16 to 19 wherein a subset of the plurality of CG occasions that occur in time after the UE performs the RA can be used by the UE.

Embodiment 22: The method of any of embodiments 16 to 21 wherein the one or more criteria for performing the RA further comprise a criterion that additional data waiting for transmission at the UE has at least a certain priority (e.g., at least a certain QoS priority or at least a LCH priority).

Embodiment 23: The method of any of the previous embodiments, further comprising: obtaining user data; and forwarding the user data to a host or a user equipment.

### GROUP C EMBODIMENTS

Embodiment 24: A user equipment comprising: processing circuitry configured to perform any of the steps of any of the Group A embodiments; and power supply circuitry configured to supply power to the processing circuitry.

Embodiment 25: A network node comprising: processing circuitry configured to perform any of the steps of any of the Group B embodiments; and power supply circuitry configured to supply power to the processing circuitry.

Embodiment 26: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 27: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 28: The method of the previous embodiment, further comprising: at the host, executing a host application associated with a client application executing on the UE to receive the user data from the UE.

Embodiment 29: The method of the previous embodiment, further comprising: at the host, transmitting input data to the client application executing on the UE, the input data being provided by executing the host application, wherein the user data is provided by the client application in response to the input data from the host application.

Embodiment 30: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 31: The host of the previous 2 embodiments, wherein: the processing circuitry of the host is configured to execute a host application, thereby providing the user data; and the host application is configured to interact with a client application executing on the UE, the client application being associated with the host application.

Embodiment 32: The host of the any of the previous 2 embodiments, wherein the initiating receipt of the user data comprises requesting the user data.

Embodiment 33: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 34: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a user equipment the method comprising:
while in an inactive state:
transmitting, to a network node, a Radio Resource Control (RRC) Resume Request with first data using a Configured Grant (CG) occasion from among a plurality of CG occasions configured for the UE;
determining that one or more criteria for performing a Random Access (RA) have been satisfied, wherein the one or more criteria for performing the RA comprise a criterion that an amount of time until a next CG occasion from among the plurality of CG occasions is greater than a certain amount of time; and
responsive to determining that the one or more criteria for performing a RA have been satisfied, performing a RA during which the UE retransmits the RRC Resume Request with the first data.

2. (canceled)

3. The method of claim 1, wherein the criterion is a criterion that an amount of time until a next valid CG occasion from among the plurality of CG occasions is greater than a certain amount of time.

4. The method of claim 3, wherein the next valid CG occasion is a next CG occasion with a same Synchronization Signal Block (SSB) association as the CG occasion in which the RRC Resume Request with the first data was transmitted or a CG occasion with an SSB association where the SSB Reference Signal Received Power (RSRP) is above a certain threshold.

5. The method of claim 1, wherein the one or more criteria for performing the RA comprise a criterion that a response to the RRC Resume Request has not been received from the network node within a certain amount of time.

6. The method of claim 5, wherein the certain amount of time is a function of a periodicity of the plurality of CG occasions.

7. The method of claim 1, wherein the one or more criteria for performing the RA comprise a first criterion that a response to the RRC Resume Request has not been received from the network node within a first amount of time and a second criterion that an amount of time until a next CG occasion from among the plurality of CG occasions is greater than a second amount of time.

8. The method of claim 1, further comprising:
while in a connected state, receiving, from a network node, an RRC Release message comprising a Configured Grant Small Data Transmission (CG-SDT) configuration that configures the UE with the plurality of CG occasions; and
transitioning to the inactive state in response to receiving the RRC Release message.

9. The method of claim 8, wherein the one or more criteria for performing the RA comprise: a first criterion that a response to the RRC Resume Request has not been received from the network node within a first amount of time, a second criterion that an amount of time until a next CG occasion from among the plurality of CG occasions is greater than a second amount of time, or both the first criterion and the second criterion.

10. The method of claim 9, wherein the one or more criteria for performing the RA comprise the second criterion, and the second amount of time is defined by the CG-SDT configuration.

11. The method of claim 10, wherein the second criterion is a criterion that an amount of time until a next valid CG occasion from among the plurality of CG occasions is greater than the second amount of time.

12.-22. (canceled)

23. A user equipment (UE) adapted to:
while in an inactive state:
transmit, to a network node, a Radio Resource Control (RRC) Resume Request with first data using a Configured Grant (CG) occasion from among a plurality of CG occasions configured for the UE;
determine that one or more criteria for performing a Random Access (RA) have been satisfied, wherein the one or more criteria for performing the RA comprise a criterion that an amount of time until a next CG occasion from among the plurality of CG occasions is greater than a certain amount of time; and
responsive to determining that the one or more criteria for performing a RA have been satisfied, perform a RA during which the UE retransmits the RRC Resume Request with the first data.

24.-32. (canceled)

33. A method performed by a network node, the method comprising:
transmitting a Radio Resource Control (RRC) Release message to a User Equipment (UE) wherein the RRC Release message comprises a Configured Grant Small Data Transmission (CG-SDT) configuration that configures the UE with a plurality of Configured Grant (CG) occasions for CG-SDT and one or more parameters related to one or more criteria for the UE to perform Random Access (RA) for retransmission of a CG-SDT;
wherein the one or more criteria for the UE to perform RA for retransmission of a CG-SDT comprise a criterion that an amount of time until a next CG occasion from among the plurality of CG occasions is greater than a certain amount of time.

34.-45. (canceled)

46. A network node comprising processing circuitry configured to cause the network node to:
transmit a Radio Resource Control (RRC) Release message to a User Equipment (UE) wherein the RRC Release message comprises a Configured Grant Small Data Transmission (CG-SDT) configuration that configures the UE with a plurality of Configured Grant (CG) occasions for CG-SDT and one or more parameters related to one or more criteria for the UE to perform Random Access (RA) for retransmission of a CG-SDT;
wherein the one or more criteria for the UE to perform RA for retransmission of a CG-SDT comprise a criterion that an amount of time until a next CG occasion from among the plurality of CG occasions is greater than a certain amount of time.

47. (canceled)

48. The UE of claim 23, wherein the criterion is a criterion that an amount of time until a next valid CG occasion from among the plurality of CG occasions is greater than a certain amount of time.

49. The UE of claim 48, wherein the next valid CG occasion is a next CG occasion with a same Synchronization Signal Block (SSB) association as the CG occasion in which the RRC Resume Request with the first data was transmitted or a CG occasion with an SSB association where the SSB Reference Signal Received Power (RSRP) is above a certain threshold.

50. The UE of claim 23, wherein the one or more criteria for performing the RA comprise a criterion that a response to the RRC Resume Request has not been received from the network node within a certain amount of time.

51. The UE of claim 50, wherein the certain amount of time is a function of a periodicity of the plurality of CG occasions.

52. The UE of claim 23, wherein the one or more criteria for performing the RA comprise a first criterion that a response to the RRC Resume Request has not been received from the network node within a first amount of time and a second criterion that an amount of time until a next CG occasion from among the plurality of CG occasions is greater than a second amount of time.

53. The UE of claim 23, further adapted to:
while in a connected state, receive, from a network node, an RRC Release message comprising a Configured Grant Small Data Transmission (CG-SDT) configuration that configures the UE with the plurality of CG occasions; and
transition to the inactive state in response to receiving the RRC Release message.

54. The UE of claim 53, wherein the one or more criteria for performing the RA comprise: a first criterion that a response to the RRC Resume Request has not been received from the network node within a first amount of time, a second criterion that an amount of time until a next CG occasion from among the plurality of CG occasions is greater than a second amount of time, or both the first criterion and the second criterion.

55. The UE of claim 54, wherein the one or more criteria for performing the RA comprise the second criterion, and the second amount of time is defined by the CG-SDT configuration.

56. The UE of claim 55, wherein the second criterion is a criterion that an amount of time until a next valid CG occasion from among the plurality of CG occasions is greater than the second amount of time.
